(19) United States
(12) Patent Application Publication
(10) Pub. No.: US 2013/0028419 A1
(43) Pub. Date: Jan. 31, 2013

(54) SYSTEM AND A METHOD FOR USE IN A SYMMETRIC KEY CRYPTOGRAPHIC COMMUNICATIONS

(71) Applicants: Debabrata Das, Burdwan (IN); Anirban Das, Burdwan (IN); Debjani Das, Burdwan (IN); Prasanta Bhattacharjee, Burdwan (IN)

(72) Inventors: Debabrata Das, Burdwan (IN); Anirban Das, Burdwan (IN); Debjani Das, Burdwan (IN); Prasanta Bhattacharjee, Burdwan (IN)

(21) Appl. No.: 13/557,112

(22) Filed: Jul. 24, 2012

(30) Foreign Application Priority Data
Jul. 26, 2011 (IN) 992/KOL/2011

(51) Int. Cl. H04L 9/32

(52) U.S. Cl. 380/259

(57) ABSTRACT

The present invention relates to a system and a method for secured transmission/and storage of encrypted data in all the applicable modes of data storage. The method comprises the steps of providing the data, generating a password or a key by a user, encrypting the data by the password or the key for plural number of times resulting plurality of cipher texts, sending plurality of the cipher texts and the password or key, and decrypting the cipher text by the password or the key. The system comprises input device means for providing the data, input device means for generating a password by a user, processor means encrypting the data by the password or key for plural number of times resulting plurality of cipher texts, means for sending the plurality of cipher texts and the password and means for decrypting the cipher text by the password or key.

### FIELD OF THE INVENTION

The present invention relates to a secured transmission and secured storage of data in the communication systems. More particularly, the invention is concerned about a system and a method for use in a symmetric key cryptographic communications for secured transmission and secured storage of data.

### BACKGROUND OF THE INVENTION

The need to comply to the almost ubiquitous Breach Notification Laws (for example CA SB 1386, CA AB 1950, and similar laws in 43+ more US states), adds first name, last name, driver license number and other PII to the list. In early 2008, CA AB 1298 added medical and health insurance information to PII data.

Additionally, industry specific privacy and security standards may require encryption of certain assets, plus core business assets (such as research results in the pharmaceutical industry, results of oil field exploration, financial contracts, or the personal details of informants in law enforcement) may be worth encrypting to safeguard this information on the storage medium. In the health care industry, the privacy of patient data, health records and X-ray images is of the highest importance. Most X-ray images are stored following the DICOM standard, which intentionally includes PII information into the image meta data, making image and patient data readily available to an intruder if not properly protected through encryption.

Because of legislative requirements and the sensitivity of electronic business information, organizations are increasingly deploying a variety of encryption solutions. While the focus has been on the flow of information between the business perimeter and the outside Internet, businesses also are examining options to better protect data at rest at the core of the infrastructure. Security practitioners continue to integrate virtual private networks (VPNs), secure sockets layer (SSL) and Wi-Fi protected access (WPA) technologies into the infrastructure fabric. All of these use encryption to secure data in motion security practitioners can significantly address the challenge of confidentiality in the transmission and storage of sensitive information.

California's Assembly Bill 1950 is an example of legislation that is leading businesses to deploy encryption capabilities from the edge of the network to the inside core. This bill requires businesses to protect information about California residents from unauthorized access, destruction, use, modification or disclosure encryption is a reasonable way to protect all such information. Any business that comes into sensitive information about California residents will feel the impact of this bill.

Further, wireless communication is transforming the computing infrastructure inside businesses. The number of laptops, PDAs and wireless access points (APs) continues to increase. These systems transmit sensitive information that must be protected.

Nowadays security threats become more sophisticated and data becomes ever more critical to the enterprise, customers must stay one step ahead of new and existing security threats to secure that data to the fullest possible extent.

One technology commonly leveraged to address this problem is encryption, which secures data from unauthorized access using complex keys. Storage devices such as tape drives, enterprise-class applications, network solutions and disk subsystems (such as those in virtual tape libraries) all utilize key-based encryption schemes in various forms.

Furthermore, data is not always shielded via encryption at every operational stage—at rest (when it is relatively static, such as on a tape drive), in motion (over the network) and in ongoing everyday use (in commonly-accessed documents or databases). The result is that even in organizations that have widely deployed key-based encryption, core business data is often not as well protected as it should be.

An encryption system generally performs two functions: encryption and decryption. Fundamental purpose of encrypting is to ensure privacy and data integrity. Encryption involves converting data from plaintext (or normal text) into cipher text, which makes data unintelligible to any unauthorized parties. Decryption reverses the encryption process, restoring the data to its original form.

A system's user must have a unique key in order to send or receive or store an encrypted message. The strength of an encryption system depends both upon the strength of its algorithm and, often, on the length of the keys used for encryption and decryption. A key is a mathematical value used in conjunction with a cryptographic algorithm. Longer key lengths (that is, more digits) usually mean greater security because there are more possible combinations for an unauthorized observer to examine. In a symmetric (secret key) cryptosystem, a single key is used to perform both encryption and decryption. Asymmetric (public-key) cryptosystems use different keys for encryption and decryption.

Symmetric algorithms can be divided into two categories. Some operate on the plaintext a single bit (or sometimes byte) at a time. These are called stream algorithms or stream ciphers. Others operate on the plaintext in groups of bits. The groups of bits are called blocks, and the algorithms are called block algorithms or block ciphers. For DES era computer algorithms, a typical block size is 64 bits.

There are inherent tradeoffs among the key length, the security of the encryption method, and its usefulness to groups attempting to prevent unauthorized access to encrypted information. To assure security, key length must be sufficiently great to reduce the possibility that it can be broken with “brute force” computing power.

In actuality, symmetric cryptosystems are those that use a decryption key that can be directly calculated from the encryption key and vice versa. Most symmetric cryptosystems, however, use the same key for encryption and decryption.

Technical Factors Influencing Encryption Product Selection

1. Strength

2. Speed

3. Infrastructural factors i.e., Hardware or software implementation

4. Compatibility with existing infrastructure

5. Key management requirements (security of keys, changing keys, Symmetric or Asymmetric)

Other predominant features (a) Price (b) Cost of use (c) Licensing structure also (d) Endorsements (de facto, de jure) and (e) Export controls (f) Government requirement In modern telecommunications and computer systems, encryption is involved at multiple points.

Various systems have been developed in the prior art for enciphering messages to maintain the security and privacy of data communications and data storage. One such system is the block cipher system, which is a substitution technique, in which the entire block is enciphered in accordance with a predetermined cipher key. The resulting substituted message is unintelligible cipher text which cannot be understood without knowledge of the cipher key. An advantage of the substitution technique operating in accordance with a predetermined cipher key is that the deciphering operation is easily implemented by a reverse application of the cipher key. Further teachings on the design and principles of substitution techniques may be found in “Communication Theory of Secrecy Systems” by C. E. Shannon, Bell System Technical Journal, Vol. 28, pages 656-715, October 1949, and in “Cryptography and Computer Privacy” by H. Feistel, Scientific American, Vol. 228, No. 5, pages 15-23, May 1973. Both Shannon and Feistel expound on a product cipher system in which two or more ciphers are successively combined, as for example, by successive states of nonlinear substitution followed by linear transformation.

There are two symmetric key cryptographic functions of real-world significance {the RC6 block cipher and the SecurID hash function. RC6 was a widely acclaimed finalist candidate for the Advanced Encryption Standard. It is owned and promoted by RSA Security, and therefore is likely to be used within million s of products worldwide. SecurID is an authentication hardware token also owned by RSA Security. It is known to be used by over 13 million people in over 80 countries throughout the world.

The RC6 block cipher was designed by cryptographic experts and supported by extensive public security analysis, more specifically, demonstrating the resistance of RC6 to differential cryptanalysis, which is a major portion of the complete security analysis of RC6. In contrast, the SecurID hash function was designed in secret and kept secret for many years. After the device was reverse engineered and source code was published on the web, security weaknesses soon began to appear.

The style of research in symmetric key cryptography has lagged behind that of public key cryptography, the reason being the performance requirements. Nobody has found an efficient way of doing symmetric key cryptography (in the complexity theoretic model) which is provably as secure as some assumed hard mathematical problem.

For this reason, the best one can do is to design heuristic methods that are secure against all types of attacks that have been discovered in the history of the subject. The rule of thumb is that a symmetric key method can begin to be trusted after a lot of experts have studied it and gained confidence in it. For now, this seems to be working, and one can also say that the converse is true: systems which have not been widely studied by the experts are almost always insecure. But, it should be evident that the discovery of an efficient, provably secure symmetric key method will result in a great breakthrough in modern cryptography.

Two of the most important primitives in symmetric key cryptography are block ciphers and hash functions. Informally, block ciphers break messages into fixed length \blocks” and encrypt them one at a time in a way that depends upon a secret key. Their primary purpose is to provide secrecy of data, assuming that the secret key is available only to the intended parties. Hash functions are functions that map an arbitrary length input to a fixed length output. Hash functions maybe used for many purposes, but here concerned with only keyed hash functions for the application of authentication. Both of these are of real-world significance. RC6 was a widely acclaimed finalist candidate for the Advanced Encryption Standard (AES) and SecurID is the most popular authentication device of its type in the world {used by over 13 million people.

U.S. Pat. No. 7,356,140 entitled “encrypting device, decrypting device, cryptosystem including the same devices, encrypting method, and decrypting method” teaches a cryptosystem includes an encrypting device, a communication path, and a decrypting arithmetic device. Key generation means in the encrypting device generate a public key {g.sub.1, g.sub.2} as random numbers respectively including the power of (p-1) and the power of (q-1) and decrypt a message m using the Fermat's little theorem and the Chinese remainder theorem. This makes it possible to suggest an extremely simple cryptosystem, which is simplified by reducing the amount of computations for encryption and decryption and enables encryption and decryption by simple calculations, while maintaining a security equivalent to the RSA encryption scheme.

U.S. Pat. No. 7,779,272 entitled “hardware cryptographic engine and encryption method” teaches a hardware cryptographic engine for encrypting transmission data may include a plurality of cipher text engines that generate intermediate cipher texts and final cipher texts. At least one of the cipher text engines may receive an intermediate cipher text output from at least one neighboring cipher text engine to generate a corresponding intermediate cipher text and final cipher text. A method of encrypting transmission data may include inputting a second intermediate cipher text of a second cipher text engine to a first cipher text engine and generating a first intermediate cipher text of the first cipher text engine using the second intermediate cipher text.

U.S. Pat. No. 7,809,134 entitled “Method for encrypting information and device for realization of the method” teaches the cryptographic system and method for securing data from unauthorized access includes, in one embodiment, an iterative probabilistic cipher for converting plaintext into cipher text comprising at least two components, a core and a flag. A corresponding key and the core and flag may be output in one or more data channels. For each round of encryption additional keys, cores and flags can be generated. Unless all keys, cores and flags are known, no recovery of the plaintext can be possible.

US 20060193472 entitled “Secure encryption system, device and method” teaches a system, device and method for encrypting plaintext information securely. The system includes a transmitting agent to generate and synchronize a first cipher stream using the plaintext information and a first key, to generate and synchronize a second cipher stream using a second key and a randomizing function to randomize and synchronize a controllable plaintext stream to form a second synchronized cipher stream, and to operate on the plurality of first and second cipher streams using an exclusive disjunction operator to obtain a cipher text stream; and a receiving agent to decrypt the cipher text stream.

One of the disadvantages of the existing technology is that the state of the art implementations in the symmetric key authentication services are based on ten year old designs and no new symmetric key authentication technique is provided high secured data transmission. Further, existing symmetric key authentication infrastructures require the participation of the TTP not only during the authentication phase, but also for generating the session key. Thus, the TTP is actively involved every time any two clients need to establish a secure connection. This leads to the following shortcomings.

The Authentication Server (AS) is a single point of failure because when the AS is out of service users cannot independently establish a new secure session. This makes it a particularly attractive target for DoS attacks. The AS is a performance bottleneck, since all the users need to contact the server for each new session they want to establish. Session keys are generated and distributed by the AS upon request. This means the AS server must be on-line. As a consequence the AS is a highly sensitive target since compromising the AS would result in a possible compromise of all the subsequent private communications among all users registered with that particular AS. Furthermore key material is continuously exposed since the AS needs to be online.

The disadvantages of the present day symmetric key cryptographic function is that there was no provision for data origin authentication and data integrity protection. In other words the recipient can neither authenticate the sender nor verify the decrypted message as the original message.

Thus, there is a need to overcome the problems of the prior art. After doing lot of experiments and research works, the inventors of the present invention has provided a system and a method for secured transmission and storage of data by encrypting the data with a symmetric key which would provide high security to the data and is difficult to tamper the data by unauthorized users. In the present invention procedure of encrypting and decrypting is dependent upon a mathematical procedure not used by the Cryptographers and the mathematicians till date. In the present invention, authentication infrastructure would overcome these limitations, and at the same time is better suited for the re-shaped distributed computing landscape. The pivotal point in the design is placing the AS server on-line. This would reduce the risk of compromising the AS's cryptographic material, shields it from DoS attacks, and makes the infrastructure more appropriate for environments such as MANET, where continuous network connectivity cannot be assumed.

### OBJECTS OF THE INVENTION

An object of the present invention is to overcome the problems/disadvantages of the prior art.

Another object of the present invention is to provide a method for secured transmission and storage of data.

Another object of the present invention is to provide a system for secured transmission and storage of data.

These and advantages of the present invention will become readily apparent from the following detailed description taken in conjunction with the accompanying drawings.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

According to one aspect of the present invention there is provided a method for secured transmission and storage of encrypted data said method comprising:

feeding/providing the data to be transmitted/stored;

generating a password or a key for encryption by a user;

encrypting said data by said password or said key for plural number of times resulting in plurality of cipher texts;

storing said encrypted data in the form of said cipher texts in non transient computer programme readable medium

sending/storing plurality of said cipher texts and said password or said key to a user or users to whom data is intended to be sent; and

decrypting said plurality of cipher texts by said password or said key.

According to another aspect of the present invention there is provided a system for secured transmission/and storage of encrypted data said system comprising:

means for providing/feeding the data to be transmitted/stored;

means for generating a password by a user;

processor means encrypting said data by said password or said key for plural number of times resulting in plurality of cipher texts;

means for storing the said encrypted data;

means for sending said plurality of encrypted data in the form of cipher texts and the password to a user or users to whom data is intended to be sent; and

means for decrypting said plurality of cipher texts by said password or said key.

### BRIEF DESCRIPTION OF THE ACCOMPANYING DRAWINGS

Other features as well as the advantages of the invention will be clear from the following description.

In the appended drawings:

FIG. 1 illustrates a schematic diagram of Encryption process

FIG. 2 illustrates a schematic diagram of Decryption process

### DETAILED DESCRIPTION OF THE ACCOMPANYING DRAWINGS

In the following detailed description, reference is made to the accompanying drawings that form a part hereof, and illustrate the best mode presently contemplated for carrying out the invention. Further functioning of the system has been discussed below to describe the way the system operates. However, such description should not be considered as any limitation of scope of the present unit. The system thus conceived is susceptible of numerous modifications and variations, all the details may furthermore be replaced with elements having technical equivalence. In practice the materials and dimensions may be any according to the requirements, which will still be comprised within its true spirit.

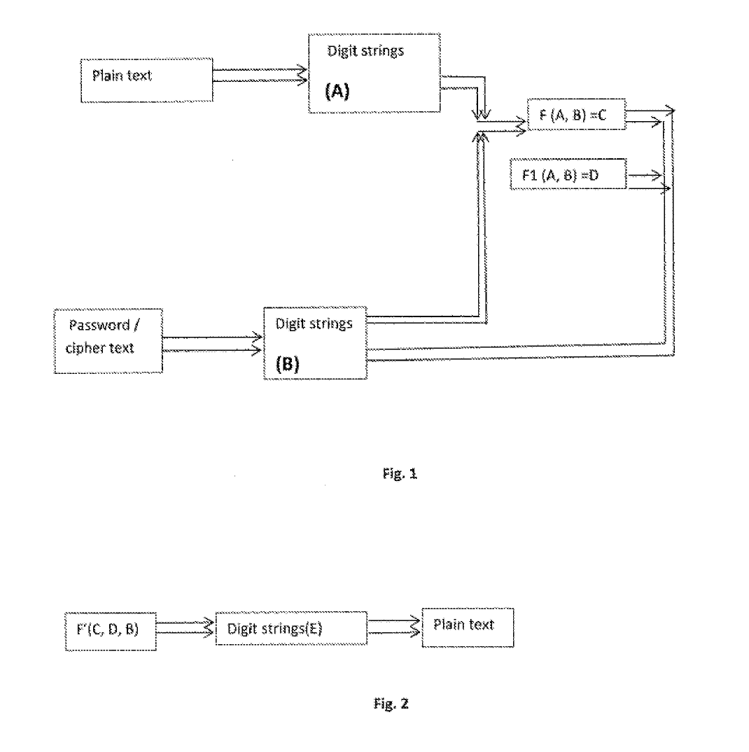

According to the invention there is provided a system and a method for secured transmission/secured storage of data by encrypting the data with a symmetric key. As shown in FIG. 1, the term Plain text includes any of text, images, videos, audios, data files, data stream, and digital media and the like. Digital strings with the help of any method of character to digital conversion procedure available or agreed upon between the communicating parties like ASCII,ANSI, ITU, and ISO standards. Plaintext is being converted to a digital string (being termed as A in the FIG. 1).

Similarly password or the cipher key (being any of the key board characters) is again being converted to another digit string (being termed as B in the FIG. 1). Then a math function f(A,B) is being run to generate C(being termed as the first cipher text). Then another math function f1 (A, B) is again run to generate D (being termed as the second cipher text). After these two performances the encryption function is complete and also the process of creation of two cipher texts C and D is also complete.

As shown in FIG. 2, for the decryption of the encrypted text (with an intention to get back to the original plain text for a valid user who is having the cipher text) one can run a function f2 (B,C, D) where B is the cipher key and C and D are the encrypted parts of the plain text A. The decryption function again generates a digit string E. From the said digit string (E) if one can run the decimal to character conversion then recover the plaintext.

The transformation function can be activated at the moment any person with a view to encrypt a plaintext through the provided Symmetric Key Cryptographic function which enables the person to select his own key in the form of a password. The password or the key may be of any size at least 10 digits minimum which can be made at least 32 bits. Any message in the form of plaintext, data or transaction is to be sent to the receiver's end in an unintelligible form but the right to convert the previous unintelligible form to a intelligible text form with the help of the cipher key or the password held only with the authority or be store in cipher text mode in its truest sense.

The text message is to be converted into digits with the help of any known procedure or any secret procedure as dependent on any agreed norm between the sender and the receiver or on the choice of the person or organization engaged in this type of data transmission.

The sender of any message/data/plaintext when puts the cipher key/password with a view to change his message in an unintelligible form to hide the content of the plain text from the rest of the world excepting the authorized person/persons he takes help of a discrete mathematical function which creates a new set of digit which can never be related either with the input data/plaintext nor with the cipher text generated after putting the user's own key and even the password or key used to encrypt that specific set of data will not have any relation to the plaintext. In the present invention, if the exact or correct cipher key is not used the receiver of the encrypted message will never be able to derive any conceivable message from that encrypted message.

The process of data encryption is complete and whenever the user wants to decrypt the set of data in encrypted form with the help of his own key or password the user is to put his previous password which was originally used to encrypt.

According to the invention there is provided a method for secured transmission/storage of data by encrypting the data with a symmetric key. The method steps include data is being input in the programme through the key board. The cryptographic function uses any type of character to digital converter like the procedures and standards of American standard code for information interchange or the procedure and standards of American national standards institute, or the standards of international telecommunication union to generate a compact set of digital representation of the originally inputted set of characters. The function needs only a digital representation whatever may be the original input. The above functions are being performed with a view to convert the plaintext/message/data originally inputted via the keyboard of the terminal into a unintelligible form of digital representation from which the original plaintext/data/message is impossible to recover.

To arrive at such a situation as the procedure adopted needs a private key which may be termed as cipher key or password. The cipher key can be generated also from the keyboard as the intention of the person or organization who wants to use this cryptographic function. The person generates a cipher key or password with the help of the keyboard. From the characters thus generated digital transformation is allowed to take place as per the standard and agreed norms of data conversion. These two set of digits thus generated are put into a function thereby generating a new string of digit totally unrelated from both the original set of digits generated earlier i.e., the set of digits generated form the plaintext/message/data and the secondary form of digit string generated from the cipher key/password chosen by the user with an intention to convert his plaintext/message/data into an unintelligible form of digits to the eavesdropper/hacker/or any other unauthorized person during transmission of the data or being stationed at any point.

The cryptographic function besides generating the digit string also generates another digit string and again having any relation neither with the original plaintext/data etc which is to be converted into a cipher text nor with the cipher key (which is being instrumental to convert the plain text into the cipher text)

Usually till date all the private/symmetric key cryptographic functions needed two instruments for performing the encryption and decryption functions i.e., the cipher text generated with the help of the cipher key and the subsequent transformation to plaintext form cipher text. But in this invention, two types of cipher text are generated and both become equally instrumental when the decryption function takes place. When the decryption function takes place both the cipher texts as detailed above becomes instrumental to convert the cipher text to the primary digit string or the original digit string. From the original digit string thus obtained the function is to reverse engineer the previous function of character to digital form and in detail the function converts the digit string to character to get back the original plain text. As a basic rule of Cryptography this function may be recognized as one type of mechanism for achieving highest degree of data security and privacy in that it protects the data itself rather than the medium of transmitting/storing data.

If the cipher key or the key with which the plaintext is being converted to an unintelligible set of digits is made of 10-12 characters at least 20-30 decimal digits are being generated when converting to decimal through any approved mode (ASCII, ANSI, OR ITU, OR ISO STANDARDS) and the number of bits thus generated if be of 128 bits then traditionally the cipher key can be termed as 128 bit key.

To check the security level of this 128 bit key, suppose having an integrated circuit which could perform one million encryptions (on any standard encryption function) per second, and built a massive computer containing one million of these chips to forcibly try all keys of the encryption function which is being used).

As such this computer is capable of testing 10¹² encryptions per second would require 2¹¹²=5.19×10³³ encryption operations==5.19×10³³ encryption operations/10¹² operations/sec=5.19×10²¹ sec=1.65×10¹⁴ years.

This is more than 16,453 times older than the current estimated age of the universe (which has been calculated as 10¹⁰ years).

The most unique feature of the invention is that it is not dependent on prime numbers only rather it works on all the three types of integer i.e., even integers, and both the parts of odd integer (primes and non-primes) and this property of the invention is not yet being used even in the most widely used cryptosystems in the World.

This invention can be used as a very effective tool for hiding any type of secret and security documents to avoid any sort of data piracy, may be used as an anti money laundering software and a very special type of password shield and many other uses which are known to all as uses of these types of software are need of the day.

If the original intelligible message referred to as plaintext is converted into apparently random nonsense referred to as cipher text with the help of conventional encryption and the key for conversion is decided upon mutual agreement wherein the key may be transmitted to the receiver through a secured channel with the help of a secret algorithm.

In all the above functions of the procedure only integers have been used and the integers may either positive integers, negative integers, decimals and fractions but no bit function is being applied but any user may apply any sort of prevalent bit function with a view to have greater height of data security.

The encrypted text or cipher text can again be encrypted multiple times with the help of the same cipher key (using multiple times) or with the help of another separate cipher keys each time but in that case the decryption function will follow the reverse procedure so to say last time the cipher key used for encryption will have to be the first cipher key for decryption.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor (e.g., a central processing unit (CPU), a graphics processing unit (GPU, or both), a main memory and a static memory, which communicate with each other via a bus. The machine may further include a video display unit (e.g., a liquid crystal display (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

The disk drive unit may include a machine-readable medium on which is stored one or more sets of instructions (e.g., software) embodying any one or more of the methodologies or functions described herein, including those methods illustrated above. The instructions may also reside, completely or at least partially, within the main memory, the static memory, and/or within the processor during execution thereof by the machine. The main memory and the processor also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a non transitory machine readable medium containing instructions, or that which receives and executes instructions from a propagated signal so that a device connected to a network environment can send or receive voice, video or data, and to communicate over the network using the instructions. The instructions may further be transmitted or received over a network via the network interface device.

While the non transitory machine-readable medium can be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: tangible media; solid-state memories such as a memory card or other package that houses one or more read-only (non-volatile) memories, random access memories, or other re-writable (volatile) memories; magneto-optical or optical medium such as a disk or tape; non-transitory mediums or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

### ADVANTAGES OF THE INVENTION

1. Highly secured.

2. Impossible to hack/crack the data.

3. Less computation time.

4. Effective tool for hiding any type of secret documents.

5. Avoid any sort of data piracy.

1. A method for secured transmission and storage of encrypted data said method comprising:
feeding/providing the data to be transmitted/stored;
generating a password or a key for encryption by a user;
encrypting said data by said password or said key for plural number of times resulting in plurality of cipher texts;
storing said encrypted data in the form of said cipher texts in non transient computer programme readable medium sending plurality of said cipher texts and said password or said key to a user or users to whom data is intended to be sent; and
decrypting said plurality of cipher texts by said password or said key.

2. The method as claimed in claim 1, wherein said data comprises alpha-numeric data.

3. The method as claimed in claim 1, wherein said password or said key comprises at least 128 bits.

4. The method as claimed in claim 1, wherein said key is a symmetric key.

5. The method as claimed in claim 1, wherein said encryption being based on discrete algorithm.

6. The method as claimed in claim 1, wherein said data being encrypted by the password or the key for at least two times.

7. The method as claimed in claim 1, wherein said cipher texts comprise cipher text1 and cipher text 2.

8. The method as claimed in claim 1, optionally comprises plurality of passwords or plurality of keys adapted for encrypting the data for plural number of times.

9. The method as claimed in claim 1, wherein said encryption being done at client side or server side or both.

10. The method as claimed in claim 1 is adapted to be worked on even integers and/or odd integers.

11. The method as claimed in claim 1 wherein in the decrypting step cipher texts become instrumental to convert the cipher text to the primary digit string or original digit string.

12. The method as claimed in claim 1 is further storable in CLOUD or other portable data storage device or other applicable modes for data storage and the like.

13. A system for secured transmission/and storage of encrypted data said system comprising:
means for providing/feeding the data to be transmitted/stored;
means for generating a password by a user;
processor means encrypting said data by said password or said key for plural number of times resulting in plurality of cipher texts;
means for storing the said encrypted data;
means for sending said plurality of encrypted data in the form of cipher texts and the password to a user or users to whom data is intended to be sent; and
means for decrypting said plurality of cipher texts by said password or said key.

14. A computer program product wherein the program instructs the computer processor to perform the following steps for secured transmission/and storage of encrypted data:
feeding/providing the data to be transmitted/stored;
generating a password or a key for encryption by a user;
encrypting said data by said password or said key for plural number of times resulting in plurality of cipher texts;
storing said encrypted data in the form of said cipher texts in non transient computer programme readable medium sending plurality of said cipher texts and said password or said key to a user or users to whom data is intended to be sent; and
decrypting said plurality of cipher texts by said password or said key.

15. A non transitory computer readable medium with an executable program stored thereon, wherein the program instructs the computer processor to perform the following steps for secured transmission/and storage of encrypted data:
feeding/providing the data to be transmitted/stored;
generating a password or a key for encryption by a user;
encrypting said data by said password or said key for plural number of times resulting in plurality of cipher texts;
storing said encrypted data in the form of said cipher texts in non transient computer programme readable medium sending plurality of said cipher texts and said password or said key to a user or users to whom data is intended to be sent; and
decrypting said plurality of cipher texts by said password or said key.

16. (canceled)

17. (canceled)
